(19) United States
(12) Patent Application Publication
(10) Pub. No.: US 2026/0178697 A1
(43) Pub. Date: Jun. 25, 2026

(54) METHOD AND DEVICE FOR THE METHOD FOR CALCULATIONG A MATRIX PRODUCT

(71) Applicant: Robert Bosch GmbH, Stuttgart (DE)

(72) Inventors: Stefan Metzlaff, Renningen (DE); Tobias Kirchner, Ludwigsburg (DE)

(21) Appl. No.: 19/413,130

(22) Filed: Dec. 9, 2025

(30) Foreign Application Priority Data
Dec. 20, 2024 (DE) 10 2024 212 255.6

(51) Int. Cl. G06F 17/16; G06F 7/544; G06N 3/045; G06N 3/06

(52) U.S. Cl. CPC G06F 17/16; G06F 7/5443; G06N 3/045; G06N 3/06

(57) ABSTRACT

A method for calculating a matrix product of a first matrix with a second matrix on a hardware unit having an in-memory computing architecture which comprises a plurality of computing cells, each computing cell including a storage element(s) configured to store elements of the second matrix, and being designed to receive an element of a column vector of a matrix, and to calculate a partial product by multiplying the received element by an element stored in the storage element(s) and being designed to accumulate the calculated partial product to a result value. The method includes: flipping the first matrix; applying column vectors of the flipped first matrix to the computing cells; calculating partial products in parallel, and accumulating the partial products to result values in the computing cells; and bringing together the result values of the computing cells to form the matrix product.

### FIELD

The present disclosure relates to a method and a hardware unit for efficiently calculating matrix products, in particular in the case of use in neural networks such as transformer networks.

### BACKGROUND INFORMATION

Certain in-memory computing (IMC) architectures optimized for efficient calculation of convolutional neural networks (CNNs) are described in the related art. These architectures are typically based on the parallelization of scalar products of two vectors, which are the major computational load in CNNs. The weights of the neural network are stored in the memory cells of the IMC architecture and the input data is applied row by row. This enables efficient parallelization of the calculations and thus high computing power with low latency.

### SUMMARY

The example embodiments of the present disclosure having may have an advantage that such an IMC architecture can also be used to efficiently calculate neural networks of other topology, in particular transformer networks.

Aspects and example embodiments are disclosed herein.

In a first aspect, the present disclosure relates to a method for calculating a matrix product of a first matrix with a second matrix on a hardware unit having an in-memory computing architecture. Specifically, according to the first aspect, a method for calculating a matrix product of a first matrix with a second matrix on a hardware unit having an in-memory computing architecture which comprises a plurality of computing cells is provided, each computing cell comprising storage means (30), which are configured to store elements of the second matrix, and being designed to receive an element of a column vector of a matrix, and also being designed to calculate a partial product by multiplying the received element by an element stored in the storage means, and being designed to accumulate the calculated partial product to a result value. According to an example embodiment, the method comprises the following steps:
A) flipping the first matrix,
B) applying column vectors of the flipped first matrix to the computing cells,
C) calculating partial products, in particular in parallel, and accumulating the partial products to result values in the computing cells, and
D) bringing together the result values of the computing cells to form the matrix product.

Flipping the first matrix may be understood to mean operations that transform the first matrix into the flipped matrix such that the entries of a row of the first matrix are found in a corresponding column of the flipped matrix. Examples of such operations include transposing the first matrix, or rotating the first matrix by 90°, for example clockwise.

In a second aspect, the present disclosure relates to a method according to the first aspect, wherein the second matrix is split into multiple submatrices. This makes it possible to further optimize the calculation by distributing the submatrices among the available computing cells of the hardware unit.

In a third aspect, the present disclosure relates to a method according to one of the above aspects, wherein the first matrix is split into multiple submatrices and steps A) to D) are performed in each case with a submatrix of the flipped first matrix. This allows large matrices to be efficiently multiplied together in a particularly advantageous manner.

In a fourth aspect, the present disclosure relates to a method according to the second and the third aspects, wherein a specifiable submatrix of the second matrix is stored in the group of computing cells and steps A) to D) are performed for all those submatrices of the flipped first matrix that correspond to the same row indices in the flipped first matrix as each other. In some example embodiments, this method is performed for all of the submatrices of the second matrix in succession. By splitting up the blockwise multiplication of the submatrices of the first and second matrices in this way, the submatrices of the second matrix particularly rarely need to be loaded into the computing cells, making the method particularly efficient.

In a fifth aspect, the present disclosure relates to a method according to the second aspect, wherein the size of the submatrices depends on the number of available computing cells and/or the size of the first matrix. This makes it possible to dynamically adjust the submatrix size to the particular hardware and to the data to be processed.

In a sixth aspect, the present disclosure relates to a method, wherein the hardware unit additionally comprises a plurality of adders designed to sum, row by row, the partial products calculated by the computing cells. The use of dedicated adders makes it possible to further accelerate the calculation of the matrix product. In some embodiments of in-memory computing architectures, in particular of analog type, the adder may be configured as an analog-digital converter (abbreviated ADC).

In a seventh aspect, the present disclosure relates to a method, wherein the first matrix represents input data of a neural network. This illustrates the applicability of the method for calculation in neural networks which often require matrix multiplications.

In an eighth aspect, the present disclosure relates to a method according to the fifth aspect, wherein the neural network is a transformer network. Transformer networks are becoming increasingly important in various areas, and the method according to the present disclosure makes it possible to efficiently implement them on IMC architectures.

In a ninth aspect, the present disclosure relates to a hardware unit for calculating a matrix product according to one of the above-described aspects and/or embodiments. The hardware unit comprises a plurality of computing cells arranged in a matrix, and a control unit for controlling the computing cells. The specific architecture of the hardware unit makes it possible to efficiently carry out the method.

In a tenth aspect, the present disclosure relates to a hardware unit according to the seventh aspect, wherein the computing cells additionally comprise adders designed to sum the calculated partial products row by row. The integration of the adders into the computing cells makes it possible to increase the computing power of the hardware unit further.

In an eleventh aspect, the present disclosure relates to a hardware unit according to the seventh or eighth aspect, the hardware unit being part of a neural network. This illustrates the embedding of the hardware unit into a more complex processing system for the implementation of neural networks.

In a twelfth aspect, the present disclosure relates to the use of the hardware unit in an image processing system. Image processing systems constitute an important area of application for neural networks and for the hardware unit according to the present disclosure, as they require the efficient processing of large amounts of data.

Example embodiments of the present disclosure are explained in more detail in the following with reference to the figures.

### BRIEF DESCRIPTION OF THE DRAWINGS

FIG. 1 schematically shows the hardware unit for calculating a matrix product, according to an example embodiment of the present disclosure.

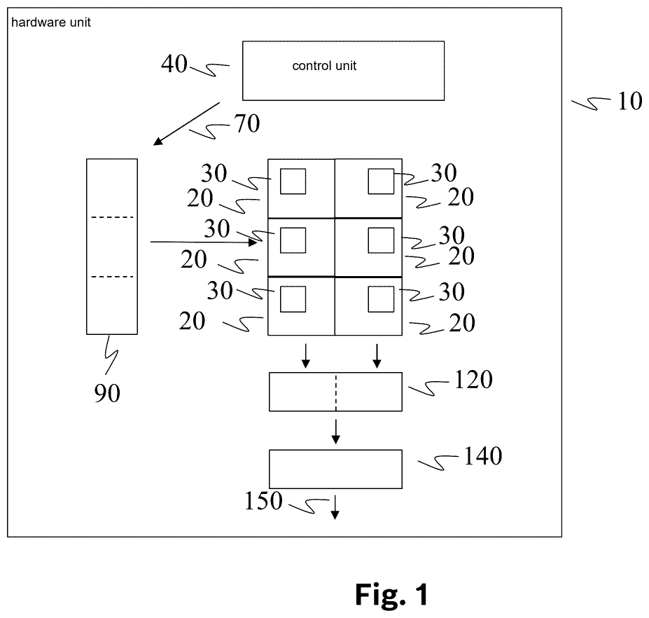

FIG. 2 shows, in a flow chart, an example embodiment for calculating a matrix product.

FIG. 3 shows, in a flow chart, aspects of a further example embodiment for calculating a matrix product.

### DETAILED DESCRIPTION OF EXAMPLE EMBODIMENTS

The hardware unit (10) comprises a plurality of computing cells (20) arranged in matrix form. Each computing cell (20) is provided with storage means (30) in which elements of the second matrix (60) are stored. The computing cells (20) are also designed to receive, in each case, an element of a column vector (90) of the flipped first matrix (70).

A control unit (40) is connected to the computing cells (20) and controls the operation thereof. The control unit (40) receives the first matrix (50) and flips it to obtain the flipped first matrix (70). Subsequently, the column vectors (90) of the flipped first matrix (70) are applied successively to the computing cells (20).

Each computing cell (20) multiplies the received element of the column vector (90) by the element of the second matrix (60) that is stored in the storage means (30) of the computing cell. The result of this multiplication, the partial product (120), is added to a result value (130) stored in the computing cell (20). This accumulation step is repeated for each element of the column vector (90).

Optionally, the hardware unit (10) may comprise additional adders (140) which serve to sum, row by row, the partial products (120) calculated by the computing cells (20).

The result values (130) of the computing cells (20) represent the elements of the matrix product (150) upon completion of the calculation and may be read by the control unit (40).

By virtue of the parallel processing in the computing cells (20), the hardware unit (10) makes it possible to efficiently calculate the matrix product (150), in particular for large matrices, which are found, for example, in neural networks.

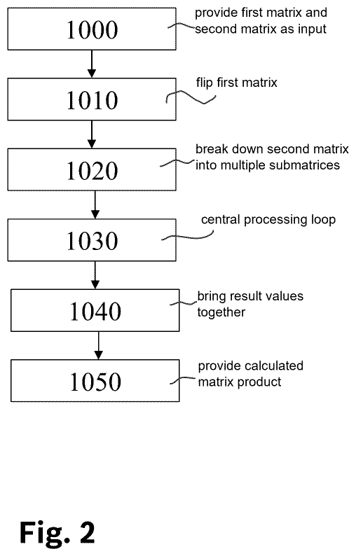

FIG. 2 shows a flow chart illustrating the sequence of one embodiment of the method for calculating a matrix product.

The method starts in step (1000) with providing the first matrix (50) and the second matrix (60) as input.

In step (1010) the first matrix (50) is flipped, creating the flipped first matrix (70).

Optionally, in step (1020) the second matrix (60) may be broken down into multiple submatrices (80). This step serves to optimize the method for parallel processing and depends on the size of the matrices and the number of available computing cells.

Step (1030) forms the central processing loop of the method, said processing loop being passed for each column vector (90) of the flipped first matrix (70) sequentially. The following actions are performed within this loop:
Applying the column vector: A column vector (90) of the flipped first matrix (70) is applied to the computing cells (20) of the hardware unit.
Calculating the partial products: Each computing cell (20) performs in parallel the multiplication of its element of the second matrix (60) or of the corresponding submatrix (80) by its assigned element of the column vector (90). The result of each multiplication is a partial product (120).
Accumulating the partial products: The partial products (120) calculated by the computing cells (20) are added up in the respective computing cells to form a result value (130).

After all column vectors of the flipped first matrix (70) have been processed, in step (1040) the result values (130) of the computing cells (20) are brought together row by row. This results in the final matrix product (150).

The method ends in step (1050) with providing the calculated matrix product (150).

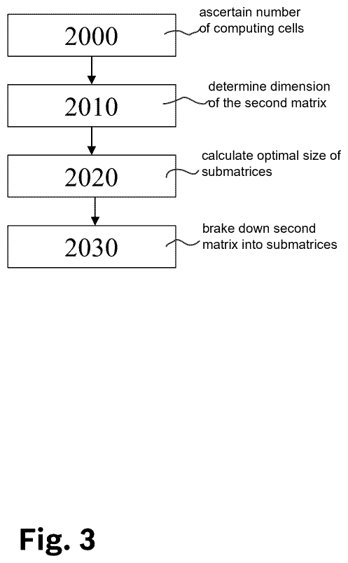

FIG. 3 shows, in a flow chart in detail, the optional step (1020) of FIG. 2 and shows how the second matrix (60) is broken down into submatrices (80) to make efficient parallel processing on the hardware unit possible. Furthermore, it illustrates the subsequent calculation of the overall matrix product (150) from the results of the submatrix multiplications.

First, in step (2000) the number (N) of computing cells (20) available on the hardware unit for the calculation is ascertained.

Then, in step (2010) the dimension of the second matrix (60), which is given by the number of rows (M) and the number of columns (P), is determined.

On the basis of the number of available computing cells (N) and the dimensions of the second matrix (M×P), step (2020) calculates the optimal size (K×L) of the submatrices (80). The optimal submatrix size depends on the specific hardware architecture and the performance targets which are pursued and is intended to ensure that the computing cells are utilized as efficiently as possible.

In step (2030), the second matrix (60) is broken down into submatrices (80) according to the previously calculated optimal size (K×L).

Step (2040) describes iteratively multiplying each submatrix (80)_i by all column vectors (90)_j of the flipped first matrix (70). These multiplications occur in parallel and generate submatrices (150)_ij of the dimension (K×1).

The submatrices (150)_ij calculated in step (2040) are combined in step (2050) according to their position within the overall matrix product (150).

Upon completion of the sequence shown in FIG. 3, the method continues with step (1040) of FIG. 2, and now the composite overall matrix product (150) is available.

1-12. (canceled)

13. A method for calculating a matrix product of a first matrix with a second matrix on a hardware unit which includes an in-memory computing architecture which includes a plurality of computing cells, each of the computing cells including storage configured to store elements of the second matrix, and being configured to receive an element of a column vector of a matrix, and also being configured to calculate a partial product by multiplying the received element by an element stored in the storage, and being configured to accumulate the calculated partial product to a result value, and the method comprising the following steps:
A) flipping the first matrix;
B) applying column vectors of the flipped first matrix to the computing cells;
C) calculating partial products in parallel, and accumulating the partial products to result values in the computing cells; and
D) bringing together the result values of the computing cells to form the matrix product.

14. The method according to claim 13, wherein the second matrix is split into multiple submatrices, and wherein each of the submatrices of the second matrix is stored by a group of the computing cells.

15. The method according to claim 13, wherein the first matrix is split into multiple submatrices and steps A) to D) are performed in each case with a submatrix of the flipped first matrix.

16. The method according to claim 14, wherein the first matrix is split into multiple submatrices, and wherein a specifiable submatrix of the second matrix is stored in the group of computing cells and steps A) to D) are performed for all those submatrices of the flipped first matrix that correspond to the same row indices in the flipped first matrix as each other.

17. The method according to claim 14, wherein a size of the submatrices depends on a number of available computing cells and/or a size of the first matrix.

18. The method according to claim 13, wherein the hardware unit includes a plurality of adders configured to sum, row by row, the partial products calculated by the computing cells.

19. The method according to claim 13, wherein the first matrix represents input data of a neural network.

20. The method according to claim 19, wherein the neural network is a transformer network.

21. A hardware unit for calculating a matrix product of a first matrix with a second matrix, comprising:
a plurality of computing cells arranged in a matrix, each of the computing cells including storage configured to store elements of a second matrix, and being configured to receive an element of a column vector of a matrix, and also being configured to calculate a partial product by multiplying the received element by an element stored in the storage, and being configured to accumulate the calculated partial product to a result value; and
a control unit configured to control the computing cells to perform a method including:
A) flipping the first matrix,
B) applying column vectors of the flipped first matrix to the computing cells,
C) calculating partial products in parallel, and accumulating the partial products to result values in the computing cells, and
D) bringing together the result values of the computing cells to form the matrix product.

22. The hardware unit according to claim 21, wherein the computing cells further include adders configured to sum, row by row, the calculated partial products.

23. The hardware unit according to claim 21, wherein the hardware unit is part of a neural network.

24. The hardware unit according to claim 21, wherein the hardware unit is used in an image processing system.
